(19) United States
(12) Patent Application Publication
(10) Pub. No.: US 2013/0132015 A1
(43) Pub. Date: May 23, 2013

(54) AUTOMATIC TESTING METHOD

(71) Applicant: Pei-Ming Chang, Taipei (TW)

(72) Inventor: Pei-Ming Chang, Taipei (TW)

(73) Assignee: PRIMAX ELECTRONICS LTD., Taipei (TW)

(21) Appl. No.: 13/410,056

(22) Filed: Mar. 1, 2012

(30) Foreign Application Priority Data
Nov. 18, 2011 (TW) 100142320

(51) Int. Cl. G06F 19/00

(52) U.S. Cl. 702/84

(57) ABSTRACT

An automatic testing method for controlling a manual test program to judge whether at least one tested object complies with a quality standard. The manual test program has a plurality of control items. The automatic testing method is executed by an electronic calculator. The automatic testing method includes steps of: (a) acquiring all control identification codes of all control items, and (b) successively performing the control items.

### FIELD OF THE INVENTION

The present invention relates to a testing method, and more particularly to an automatic testing method for use in a production line test engineering.

### BACKGROUND OF THE INVENTION

Conventionally, in the product line of an electronic product manufacturing industry or an electronic assembling plant, a test engineering is important for assuring that all electronic products or all assembled components comply with the quality standards and reliable requirements. Generally, different electronic products or different assembled components have their own testing flowcharts and testing methods. The testing flowcharts and the testing methods are written as a test program. The test program is utilized by the test engineers or the testers in the production line to perform a testing task.

FIG. 1A is a block diagram illustrating a conventional testing system. An electronic calculator 1A is electrically connected to a test jig 2A and a tested object 3A. A test program 11A is installed in the electronic calculator 1A. When the testing task is started, the test program 11A issues a testing signal S_{1A} to the test jig 2A. In response to the testing signal S_{1A}, the test jig 2A performs a testing operation on the tested object 3A. At the same time, the tested object 3A issues a corresponding feedback signal S_{2A} to the test program 11A. According to the feedback signal S_{2A}, the test program 11A will judge whether the tested object 3A complies with a quality standard or not.

FIG. 1B is a block diagram illustrating another conventional testing system. An electronic calculator 1B is electrically connected to a tested object 3B. A test program 11B is installed in the electronic calculator 1B. When the testing task is started, the test program 11B issues a testing signal S_{1B} to the tested object 3B. In response to the testing signal S_{1B}, the tested object 3B issues a corresponding feedback signal S_{2B} to the test program 11B. According to the feedback signal S_{2B}, the test program 11B will judge whether the tested object 3B complies with a quality standard or not.

FIG. 2 schematically illustrates an operating interface shown on a display screen of the electronic calculator in response to execution of a test program. The test program 11 has a plurality of control items, for example an information input control item 111, a first performance test control item 112, a second performance test control item 113, a third performance test control item 114, and a test report acquiring control item 115.

The test engineer or the tester may input an identification code of the tested object into the information input control item 111 through an input device (e.g. a keyboard or a barcode reader, not shown in the drawing). When the first performance test control item 112, the second performance test control item 113 and the third performance test control item 114 are clicked by the test engineer or the tester, the tested object is subjected to a first performance testing operation, a second performance testing operation or and a third performance testing operation, respectively. Moreover, when any of the first performance test control item 112, the second performance test control item 113 and the third performance test control item 114 is clicked, the test program 11 issues a corresponding testing signal. In response to the testing signal, the test program 11 performs a testing task on the tested object. In addition, when the test report acquiring control item 115 is clicked by the test engineer or the tester, the testing results associated with the above performance testing operations are shown on the display screen of the electronic calculator.

From the above discussions, the test engineer or the tester should successively click all of the control items in order to complete all of the performance testing operations and acquire the testing results associated with all of the performance testing operations. However, after one control item is clicked to perform a corresponding performance testing operation, a waiting time period is required to click the next control item and perform the next performance testing operation. In other words, the conventional testing method in the production line is very labor-intensive.

Generally, the test program is written by the manufacturer of the components of the electronic product. That is, the test program is not written by the test engineer or the tester. Since the source codes of the test program are not realized by the test engineer, the test engineer fails to modify the test program. Since the test program is manually executed and fails to be automatically executed, the working efficiency of the testing method in the production line is usually unsatisfied.

### SUMMARY OF THE INVENTION

The present invention provides an automatic testing method for automatically performing the testing processes in order to achieve a labor-saving purpose.

In accordance with an aspect of the present invention, there is provided an automatic testing method for controlling a manual test program to judge whether at least one tested object complies with a quality standard. The manual test program has a plurality of control items. The automatic testing method is executed by an electronic calculator. The automatic testing method includes steps of: (a) acquiring all control identification codes of all control items, and (b) successively performing the control items.

In an embodiment, the plurality of control items at least includes a switch-type control item, wherein the switch-type control item is performed when the switch-type control item is clicked, or the switch-type control item is performed in response to an enabling command.

In an embodiment, the tested object has at least one tested information, and the plurality of control items at least comprises an information-type control item, wherein the tested information is inputted into the information-type control item.

In an embodiment, the tested information is an identification code of the tested object.

In an embodiment, the steps (a) and (b) of the automatic testing method are performed by executing a plurality of function formulas under a Windows operating system of the electronic calculator.

In an embodiment, the step (a) is performed by executed a GetDlgtem function formula.

In an embodiment, the step (b) is performed by executing a Sendmessage function formula.

In an embodiment, the automatic testing method further includes a step (c) of reading a testing result corresponding to any of the control items.

In an embodiment, the step (c) of the automatic testing method is performed by executing a function formula under a Windows operating system of the electronic calculator.

In an embodiment, the step (c) is performed by executing a GetWindowText function formula.

In an embodiment, before the step (a), the automatic testing method further includes a step (d) of judging whether the manual test program is activated or not, wherein if the manual test program is not activated, the automatic testing method further comprises a step of activating the manual test program.

In an embodiment, the step (d) is performed by executing a FindWindow function formula, a Shell function formula or a ShellExecute function formula under a Windows operating system of the electronic calculator. The FindWindow function formula is executed to judge whether the manual test program is activated or not, and the Shell function formula or the ShellExecute function formula is executed to activate the manual test program.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1A is a block diagram illustrating a conventional testing system;

FIG. 1B is a block diagram illustrating another conventional testing system;

FIG. 2 schematically illustrates an operating interface shown on a display screen of the electronic calculator in response to execution of a test program;

FIG. 3 is a flowchart illustrating an automatic testing method according to an embodiment of the present invention; and

FIG. 4 schematically illustrates the control identification codes of the test program of FIG. 2 corresponding to all control items.

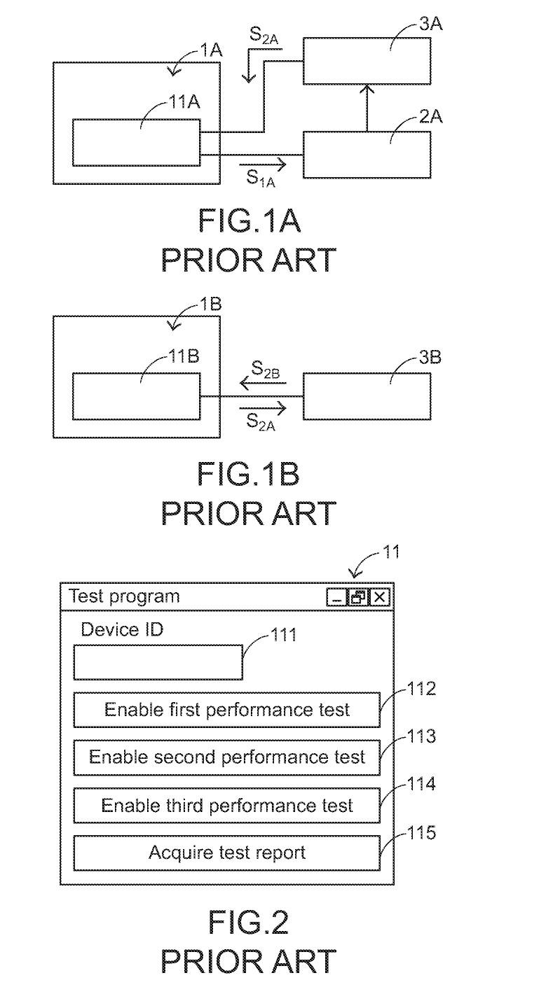

### DETAILED DESCRIPTION OF THE PREFERRED EMBODIMENT

In the context, the term “manual test program” is a test program used in the product line of an electronic product manufacturing industry or an electronic assembling plant. In addition, the manual test program is provided by the manufacturer of the components of the electronic product. The manual test program comprises a plurality of control items. The test engineer or the tester may manually and successively all of the control items in order to judge whether the tested object complies with the quality standard. Hereinafter, the term “tested object” denotes the assembled electronic product or any component of the assembled electronic product.

In this embodiment, the above control items may include switch-type control items and information-type control items. The switch-type control item is performed when the switch-type control item is clicked by the test engineer or the tester, or the switch-type control item is performed in response to an enabling command. The test engineer or the tester may input the tested information (e.g. an identification code) of the tested object into the information-type control item through an input device (e.g. a keyboard or a barcode reader). In accordance with the present invention, even if the source code of the manual test program is unavailable, the automatic testing method of the present invention is capable of judging whether the tested object complies with a quality standard or not.

From the above discussions, the automatic testing method of the present invention is capable of controlling the manual test program to be partially automated or completely automated according to the practical requirements without changing the original manual test program. Consequently, the automatic testing method of the present invention is more labor-saving in the production line. Moreover, the automatic testing method of the present invention may be executed by an electronic calculator because the operating system of the electronic calculator (e.g. the Microsoft Windows operating system) has the application program interface (API) capability. That is, the operating system of the electronic calculator can provide plentiful function formulas to be cooperated with any application program of the operating system.

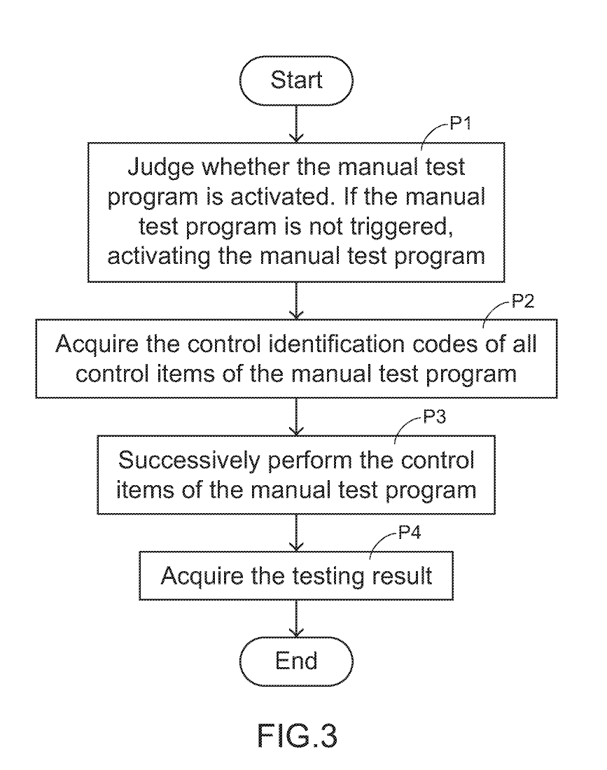

FIG. 3 is a flowchart illustrating an automatic testing method according to an embodiment of the present invention. Firstly, the step P1 is performed to judge whether the manual test program is activated. If the manual test program is not triggered, activating the manual test program. Then, in the step P2, the control identification codes of all control items of the manual test program are acquired. Then, in the step P3, the control items of the manual test program are successively performed. Afterwards, in the step P4, the testing result is acquired.

The automatic testing method of the present invention may be implemented by using the test program as shown in FIG. 2. Firstly, a first function formula under the operating system of the electronic calculator is executed to judge whether the manual test program 11 is activated or not. If the manual test program 11 is not activated, a second function formula under the operating system of the electronic calculator is executed to activate the manual test program 11.

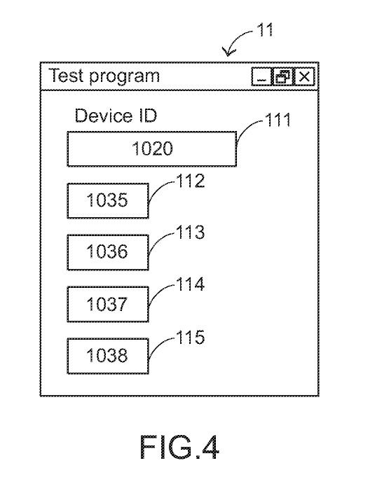

Then, a third function formula under the operating system of the electronic calculator is executed to acquire the control identification codes of the control items 111˜115. Please refer to FIG. 4, which schematically illustrates the control identification codes of the test program of FIG. 2 corresponding to all control items. The control identification codes corresponding to the information input control item 111, the first performance test control item 112, the second performance test control item 113, the third performance test control item 114 and the test report acquiring control item 115 are “1020”, “1035”, “1036”, “1037” and “1038”, respectively.

After the control identification codes“1020”, “1035”, “1036”, “1037” and “1038” corresponding to the control items 111˜115 are acquired, a fourth function formula under the operating system of the electronic calculator is executed to successively perform the information input control item 111, the first performance test control item 112, the second performance test control item 113 and the third performance test control item 114. Afterwards, a fifth function formula under the operating system of the electronic calculator is executed to read the testing results associated with the first performance test, the second performance test and the third performance test.

The timing of performing the control items 111˜115 is determined according to the practical requirements. That is, the time interval between any two control items is determined and preset by the test engineer or the tester according to the undue experiments. Moreover, the information to be inputted into the information input control item may be previously set.

In accordance with a key feature of the present invention, a plurality of existing function formulas for an application program under the operating system may be executed to acquire the program information of the application program under the operating system. The program information includes for example the control identification code of each control item of the application program or the information about whether the application program is activated. Moreover, the application program is operated according to the acquired program information.

In accordance with the present invention, the application program is the manual application program 11. If the operating system is the Windows operating system, the first function formula is a FindWindow function formula, the second function formula is a Shell function formula or a ShellExecute function formula, the third function formula is a GetDlgtem function formula, the fourth function formula is a Sendmessage function formula, and the fifth function formula is a GetWindowText function formula.

Please refer to FIG. 3 again. In the step P1, the FindWindow function formula is inputted into the window handle of the manual application program 11. If the manual application program 11 is activated, the FindWindow function formula generates a constant value. Whereas, if the manual application program 11 is not activated, the FindWindow function formula generates a zero value.

Moreover, in the step P1, after the Shell function formula or the ShellExecute function formula is inputted into the window handle of the manual application program 11, the manual application program is activated by the Shell function formula or the ShellExecute function formula.

In the step, after the GetDlgtem function formula is inputted into the window handle of the manual application program 11, the GetDlgtem function formula generates the control identification codes“1020”, “1035”, “1036”, “1037” and “1038” corresponding to the control items 111˜115 of the manual application program 11.

In the step P3, after the control identification code “1035” is inputted into the Sendmessage function formula, the first performance test control item 112 is activated by the Sendmessage function formula; after the control identification code “1036” is inputted into the Sendmessage function formula, the second performance test control item 113 is activated by the Sendmessage function formula; and after the control identification code “1037” is inputted into the Sendmessage function formula, the third performance test control item 114 is activated by the Sendmessage function formula.

In the step P4, after the control identification code “1036” is inputted into the GetWindowText function formula, the testing result of the manual application program 11 is acquired by the GetWindowText function formula.

In the above embodiment, the test program 11 shown in FIG. 2 is modified into an automatic testing method. However, those skilled in the art will readily observe that numerous modifications and alterations may be made while retaining the teachings of the invention. For example, according to the practical requirements, only some of the control items of the manual test program 11 are automatically performed, but other control items are manually performed.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An automatic testing method for controlling a manual test program to judge whether at least one tested object complies with a quality standard, said manual test program having a plurality of control items, said automatic testing method being executed by an electronic calculator, said automatic testing method comprising steps of:
(a) acquiring all control identification codes of all control items; and
(b) successively performing said control items.

2. The automatic testing method according to claim 1, wherein said plurality of control items at least comprises a switch-type control item, wherein said switch-type control item is performed when said switch-type control item is clicked, or said switch-type control item is performed in response to an enabling command.

3. The automatic testing method according to claim 1, wherein said tested object has at least one tested information, and said plurality of control items at least comprises an information-type control item, wherein said tested information is inputted into said information-type control item.

4. The automatic testing method according to claim 3, wherein said tested information is an identification code of said tested object.

5. The automatic testing method according to claim 1, wherein said steps (a) and (b) of said automatic testing method are performed by executing a plurality of function formulas under a Windows operating system of said electronic calculator.

6. The automatic testing method according to claim 5, wherein said step (a) is performed by executed a GetDlgtem function formula.

7. The automatic testing method according to claim 5, wherein said step (b) is performed by executing a Sendmessage function formula.

8. The automatic testing method according to claim 1, further comprises a step (c) of reading a testing result corresponding to any of said control items.

9. The automatic testing method according to claim 8, wherein said step (c) of said automatic testing method is performed by executing a function formula under a Windows operating system of said electronic calculator.

10. The automatic testing method according to claim 9, wherein said step (c) is performed by executing a GetWindowText function formula.

11. The automatic testing method according to claim 1, wherein before said step (a), said automatic testing method further comprises a step (d) of judging whether said manual test program is activated or not, wherein if said manual test program is not activated, said automatic testing method further comprises a step of activating said manual test program.

12. The automatic testing method according to claim 11, wherein said step (d) is performed by executing a FindWindow function formula, a Shell function formula or a ShellExecute function formula under a Windows operating system of said electronic calculator, wherein said FindWindow function formula is executed to judge whether said manual test program is activated or not, and said Shell function formula or said ShellExecute function formula is executed to activate said manual test program.
